(19) United States
(12) Patent Application Publication
(10) Pub. No.: US 2015/0157027 A1
(43) Pub. Date: Jun. 11, 2015

(54) NANOSYSTEMS FOR FORMULATION OF EFFECTIVE MINIMUM RISK BIOCIDES

(71) Applicant: CORNELL UNIVERSITY, Ithaca, NY (US)

(72) Inventor: Gary E. Harman, Geneva, NY (US)

(21) Appl. No.: 14/407,868

(22) PCT Filed: Jun. 11, 2013
(86) PCT No.: PCT/US13/45126

§ 371 Date: Dec. 12, 2014

Related U.S. Application Data
(60) Provisional application No. 61/658,750, filed on Jun. 12, 2012.

(51) Int. Cl. A01N 65/00; A01N 25/30; A01N 31/08; A01N 25/28; A01N 31/16

(52) U.S. Cl. CPC A01N 65/00; A01N 25/28; A01N 31/16; A01N 31/08; A01N 25/30

(57) ABSTRACT

The present invention relates to a composition that involves a dextrin and one or more plant treatment agents. In this composition, the dextrin and one or more plant treatment agents interact such that some of the dextrin sequesters the one or more plant treatment agents, some of the dextrin is attached to the one or more plant treatment agents, and some of the dextrin is mixed with, but unattached to, the one or more plant treatment agents. The present invention also relates to a method that involves providing a dextrin and providing one or more plant treatment agents.

This application claims the benefit of U.S. Provisional Patent Application Ser. No. 61/658,750, filed Jun. 12, 2012, which is hereby incorporated by reference in its entirety.

### FIELD OF THE INVENTION

The present invention relates to formulation of effective minimum risk biocides.

### BACKGROUND OF THE INVENTION

In the recent past, a number of natural compounds have been discovered that possess valuable properties for agricultural purposes. Such compounds may have antimicrobial or insecticidal activity, may induce resistance to plant diseases, or may enhance plant growth. Further, a number of microbes have the abilities to enhance plant growth and productivity or to protect plants from disease or pests. If properly formulated, these organisms can act as the active ingredients in pest control or plant growth promotive products. Proper formulation may include additions of materials that, in their pure form, are toxic to the agents including surfactants, UV or light protective chemicals or other materials. Finally, there are synthetic chemicals used in agriculture that would be useful in integrated pest management, e.g., as combined biological and chemical agents whose combined properties may be additive or synergistic. These materials and organisms are becoming used in agriculture, but a major difficulty is the lack of formulation technologies to overcome certain shortcomings of the natural compounds or microorganisms.

Plant terpenoids and phenylpropanoid compounds are one such group of natural compounds that have evolved in plants in large part as defense compounds against pests and diseases. They have been shown to have broad spectrum activity against a wide range of plant and animal pests and diseases, including bacteria, fungi, Oomycetes, insects, mites and nematodes. They also are quite safe for humans, and the U.S. Environmental Protection Agency has classified several materials as minimum risk pesticides exempt from the Federal Insecticide, Fungicide and Rodenticide Act (FIFRA), which otherwise requires that pesticides undergo substantial testing and stringent registration procedures. Some of the exempt products include eugenol, geraniol, thyme oil (primary active ingredient thymol), lemon grass oil (primary active ingredient citral, which is a mixture of geranal and neral), citronella and citronella oil, rosemary oil (a mixture of α-pinene, borneol, β-pinene, camphor, bornyl acetate, camphene, 1,8-cineole and limonene), mint oil, geranium oil and clove oil (primary active ingredient eugenol). Thymol also can be used as pesticide with minimal regulatory approvals. These materials are also present in foods and are used for aroma therapy since they are highly volatile and generally have a pleasant and calming odor. These and other compounds with similar composition and properties could potentially be used as highly effective and safe materials for pest control. However, they have a major drawback since they are highly volatile. Thus, if they are applied, for example, as topical sprays they rapidly volatilize into the air and are no longer effective. Therefore, there is a need to improve formulations based upon these products. Many of the pest control attributes of terpenes and their formulation to avoid volatility issues have been described by others (U.S. Patent Application Publication No. 2010/0272818 to Franklin et al. and U.S. Patent Application Publication No. 2010/0136102 to Franklin et al.). In this work, the active terpenes were enclosed within “ghosts” of yeast cells.

Other authors have recognized the need for decreasing the volatility of terpenes including linalool, 5-carvone, camphor, geraniol, λ-terpinene and fenchone, and phenylpropanoids such as E-anethose and estragole for the purpose of control of stored product pests (Lopez et al., “Analysis of Monoterpenoids in Inclusion Complexes with B-Cyclodextrin and Study on Ratio Effect in These Microcapsules,” 10th International Working Conference on Stored Product Protection Julius-Kuhn-Archiv 425 (2010), which is hereby incorporated by reference in its entirety). However, this work only describes maximum loading ratios of different compounds to cyclodextrin and does not disclose the efficacy of the resulting products for pest control.

As mentioned above, microbial agents are also useful for control of plant pests and plant growth enhancement. Organisms such as species of fungi in the genus Trichoderma, Clonostachys and Piriformasporaindica, mycorrhizal fungi, nonpathogenic Fusarium spp., binucleate Rhizoctonia spp, and bacteria such as Bacillus and Pseudomonas have an ability to colonize roots and/or leaves endophytically. These microbial agents can directly control plant diseases by their abilities to parasitize pathogenic microbes and produce antibiotics, alter plant gene and protein expression, increase resistance to stresses such as drought, salt, and the presence of pollutants, improve seed germination, increase efficiency of plant nutrient uptake, and increase plant photosynthetic efficiency (Glick et al., “Promotion of Plant Growth by ACC Deaminase-Producing Soil Bacteria,” European J Plant Pathology 119(3): 329-339 (2007); Harman, “Myths and Dogmas of Biocontrol. Changes in Perceptions Derived From Research on Trichoderma harzianum T-22,” Plant Dis. 84:377-393 (2000); Harman, “Overview of Mechanisms and Uses of Trichoderma spp.,” Phytopathology 96: 190-194 (2006); Harman, “Multifunctional Fungal Plant Symbionts: New Tools to Enhance Plant Growth and Productivity,” New Phytol. 189: 647-649 (2011); Harman, “Trichoderma—Not Just For Biocontrol Anymore,” Phytoparasitica 39: 103-108 (2011); Kloepper et al., “Plant Growth-Promoting Rhizobacteria on Canola (Rapeseed),” Plant Disease 72: 42-46 (1988); Kloepper et al., “Induced Systemic Resistance and Promotion of Plant Growth by Bacillus spp.,” Phytopathology 94: 1259-1266 (2004); Mastouri et al., “Seed Treatments With Trichoderma harzianum Alleviate Biotic, Abiotic, and Physiological Stresses in Germinating Seeds and Seedlings,” Phytopathology 100: 1213-1221 (2010); Mastouri et al., “Trichoderma harzianum strain T22 Enhances Antioxidant Defense of Tomato Seedlings and Resistance to Water Deficit,” Molec. Plant Microbe Interact. 25: 1264-1271 (2012); Sherameti et al., “The Endophytic Fungus Piriformospora indica Stimulates the Expression of Nitrate Reductase and the Starch-Degrading Enzyme Glucan-Water Dikinase in Tobacco and Arabidopsis Roots Through a Homeodomain Transcription Factor That Binds to a Conserved Motif in Their Promoters,” J. Biol. Chem 280(28): 26241-26247 (2005); Shoresh and Harman, “The Molecular Basis of Maize Responses to Trichoderma harzianum T22 Inoculation: A Proteomic Approach,” Plant Physiol. 147: 2147-2163 (2008); Shoresh et al., “Induced Systemic Resistance and Plant Responses to Fungal Biocontrol Agents,” Annu. Rev. Phyotpathol. 48: 21-43 (2010)). However, a major limitation for use of these microbial agents is the lack of adequate formulation technologies.

There are also synthetic chemicals used in agriculture that would be useful in integrated pest management. In addition, most synthetic pesticides contain a relatively high level of surfactants, stickers, and other materials. Materials to be used as pesticides usually must be distributed in concentrated form and then diluted when used. These synthetic pesticides or other chemicals may also have synergistic or additive effects with biological microbial agents if used in the diluted form, but in the concentrated form required for formulation and distribution, they are toxic to the microbial agents. Thus, the presence of surfactants, especially, when mixed with microbial agents, whether fungi or bacteria, will solubilize the membranes of the microbial spores and rapidly kill the microbial spores. This is highly undesirable since a high level of viable microorganisms is essential for these products. So, even though these materials could be highly useful in integrated pest management systems, the difficulty of making stable mixtures prevents their use.

These examples demonstrate that systems that provide stable formulations of active microbial agents or bioactive molecules would be very useful for the development and production of stable, highly active biological products in plant agriculture. Such systems would significantly increase the availability and utility of nontoxic biological or integrated biological-chemical systems for plant agriculture.

The present invention is directed to overcoming these and other deficiencies in the art.

### SUMMARY OF THE INVENTION

A first aspect of the present invention relates to a composition that involves a dextrin and one or more plant treatment agents. In this composition, the dextrin and one or more plant treatment agents interact such that some of the dextrin sequesters the one or more plant treatment agents, some of the dextrin is attached to the one or more plant treatment agents, and some of the dextrin is mixed with, but unattached to, the one or more plant treatment agents.

Another aspect of the present invention relates to a method that involves providing a dextrin and providing one or more plant treatment agents. The dextrin and one or more plant treatment agents are contacted under conditions effective for the dextrin and one or more plant treatment agents to interact such that the some of the dextrin sequesters the one or more plant treatment agents, some of the dextrin is attached to the one or more plant treatment agents, and some of the dextrin is mixed with, but unattached to, the one or more plant treatment agents.

A further aspect of the present invention relates to a composition that involves a cyclodextrin and a terpene. In this composition, the cyclodextrin and the terpene interact such that some of the cyclodextrin sequesters the terpene, some of the cyclodextrin is attached to the terpene, and some of the cyclodextrin is mixed with, but unattached to, the terpene.

A final aspect of the present invention relates to a method that involves providing a cyclodextrin and providing a terpene. The cyclodextrin and the terpene are contacted under conditions effective for the cyclodextrin and the terpene to interact such that some of the cyclodextrin sequesters the terpene, some of the cyclodextrin is attached to the terpene, and some of the cyclodextrin is mixed with, but unattached to, the terpene.

There are large numbers of opportunities to create novel, new biologically-based products for use in agriculture that enhance plant growth and performance and control pests. However, plant agriculture remains dominated by synthetic chemical approaches and products. This chemical paradigm is changing, and must change, because more and more chemicals have become banned or restricted, and some pests have developed resistance. Further, there are few new chemicals in the pipeline because the cost of development and registration are very high. The present invention helps overcome these problems in the art and demonstrates that a single type of sequestering molecule will permit a wealth of useful advantages over current methods of controlling pests and diseases of plants. The use dextrins permits production of a stable formulation which limits release of volatile materials and sequesters materials such as surfactants that would otherwise damage, for example, microbial agents.

### DETAILED DESCRIPTION OF THE INVENTION

A first aspect of the present invention relates to a composition that involves a dextrin and one or more plant treatment agents. In this composition, the dextrin and one or more plant treatment agents interact such that some of the dextrin sequesters the one or more plant treatment agents, some of the dextrin is attached to the one or more plant treatment agents, and some of the dextrin is mixed with, but unattached to, the one or more plant treatment agents.

As used herein, a “plant treatment agent” is any agent that possesses anti-microbial or insecticidal activity, protects plants from disease or pests, induces resistance to plant diseases, and/or enhances plant growth. Exemplary plant treatment agents include a microbial agent, a biostimulant, an adjuvant, a chemical pesticide, and a terpene.

As used herein, “sequester” refers to the containment, partial encapsulation, or full encapsulation of a plant treatment by a dextrin such that the plant treatment agent is released when water is added, released over time, and/or released within the gut of microorganisms.

The dextrin can be any low-molecular weight carbohydrate produced by the hydrolysis of starch or glycogen. A variety of dextrins are well known in the art. These include, without limitation, cyclodextrin, yellow dextrin, maltodextrin, amylodextrin, beta limit dextrin, alpha limit dextrin, and highly branched cyclic dextrin. In a preferred embodiment, the dextrin is cyclodextrin.

For the purposes of the present invention, it is important that the composition contains a range of interactions of the one or more plant treatment agents to the dextrin. This allows for the plant treatment agent to be sequestered at different levels such that successive waves of wetting will continue to release active ingredient. In one mode of interaction, the dextrin sequesters the plant treatment agent. Depending upon the dextrin used, the plant treatment agent may be located in the central hydrophobic cup of the dextrin thereby giving very tight complex formation, and/or the plant treatment agent may be bound to the hydrophobic portions of the outer layer of the dextrin. In another mode of interaction, the dextrin is loosely attached to the plant treatment agent. The composition also contains dextrin that is unattached to the plant treatment agent thereby resulting in free plant treatment agents within the composition.

The range of interactions of the dextrin to the plant treatment agent may be controlled by the ratio of dextrin to plant treatment agent, with higher ratios of plant treatment agents to dextrin providing a greater percentage of free and loosely attached plant treatment agents than lower ratios. In a preferred embodiment, the dextrin to one or more plant treatment agents molar ratio is 1:1 to 1:10.

In accordance with this and all other aspects of the present invention, the composition can be formulated for use in dry form as seed treatments or as soil amendments, and as liquid concentrates for foliar sprays, seed treatments and soil drenches. Either dry or liquid formulations may be used to control post-harvest diseases and pests on flowers, foods, grains, and seeds. The formulations may be used to control fungi in the genera Fusarium, Colletotrichum, Botrytis, Verticillium, Monilinia, Rhizocotnia, Alternaria, Penicillium, Aspergillus, Sclerotinia, Sclerotorium and others known in the art. The formulations may also be used to control, for example, Oomycetes including downy mildews, and Phytophthora and Pythium spp. as well as bacteria including those in the genera Clavibacter, Curtobacterium, Ralstonia, Rhodococcus, Erwinia, Xanthomonas, and Agrobacterium. In addition, thrips, caterpillars, chewing insects, root-feeding grubs and worms, sucking insects, mites, and arachnids may also be controlled.

In one particular embodiment, the plant treatment agent is a microbial agent. There are a number of microbial agents known in the art that would be useful in the composition of the present invention. For the purposes of the present invention, the microbial agent has the ability to control pests including, but not limited to, insects, mites, and other disease causing agents in plants.

In another particular embodiment, the microbial agent is selected from the group consisting of Trichoderma, Clonostachys, Rhizobia, Penicillium, Piriformasporaindica, mycorrhizal fungi, foliar endophytic fungi, nonpathogenic Fusarium spp., binucleate Rhizoctonia spp., Bacillus and Pseudomonas.

The plant treatment agent may also be a biostimulant. As used herein, the term “biostimulant” is a material which contains substance(s) and/or microorganisms whose function when applied to plants or the rhizosphere is to stimulate natural processes to benefit nutrient uptake, nutrient use efficiency, tolerance to abiotic stress, and/or crop quality, independently of their nutrient content.

In a preferred embodiment, the biostimulant is selected from the group consisting of humic acid, fulvic acid, vitamins, seaweed extract, L-amino acids, and cytokinin.

In another embodiment, the plant treatment agent is an adjuvant. As used herein, the term “adjuvant” is any substance added to a pesticide either in the formulation or at the time of application to modify and enhance the effectiveness of the pesticide, microbial agent or biostimulant.

The use of adjuvants in controlling plant pests and disease is well known in the art. Adjuvants which are routinely used include, but are not limited to, surfactants, petroleum oil concentrates, vegetable oils, ammonium fertilizers, wetting agents, dyes, drift control agents, foaming agents, thickening agents, deposition agents, water conditioners, compatibility agents, pH buffers, humectants, defoaming and antifoam agents, and UV absorbents.

In a preferred embodiment, the adjuvant is a surfactant or a natural or modified vegetable oil. Trisiloxane surfactants are an example of surfactants useful for the present invention. Other surfactants are likely to have utility as well. Dyne-Amic contains organosilicone and polyalkylene oxide polymers (U.S. Pat. No. 5,104,647 to Policello, which is hereby incorporated by reference in its entirety) and these classes of surfactants can function to enhance activity of certain formulations. Dyne-Amic also contains methylated vegetable oils. Other materials likely to be useful include soaps (salts of fatty acids) and saponins Some of these, such as the saponin from Cussonia spicata, have pesticidal action as molluscicides. Others may have fungicidal activity (MARSTON AND HOSTETTMANN, BIOLOGICAL CHEMISTRY AND BIOCHEMISTRY OF PLANT TERPENOIDS 264-286 J. B. HARBORNE AND F. A. THOMAS-BARBERAN eds., CLARENDON PRESS 1991, which is hereby incorporated by reference in its entirety), while some are highly effective in control of Oomycetes (Stanghellini et al., “Efficacy of Nonionic Surfactants in the Control of Zoospore Spread of Pythium aphanidermatum in a Recirculating Hydroponic System,” Plant Disease 80(4): 422-428, which is hereby incorporated by reference in its entirety). Vegetable oils used as adjuvants are usually emulsified and can originate from a variety of crop sources. Vegetable oils may also be esterified to give a lower viscosity than the natural oil.

In another embodiment, the plant treatment agent is a chemical pesticide. As used herein, the term “pesticide” encompasses insecticides, miticides, molluscicides, nematicides, herbicides, rodenticides, and fungicides. There are a number of chemical pesticides which are well known in the art. Examples of chemical pesticides include, but are not limited to, organophosphate pesticides, carbamate pesticides, organochlorine pesticides, pyrethroid pesticides, and sulfonylurea pesticides.

In another embodiment, the plant treatment agent is a terpene. As used herein, the term “terpene” refers to terpenes of formula (C₅H₈)ₙ but also encompasses terpene derivatives, such as terpene aldehydes or terpene polymers. Natural and synthetic terpenes are included, for example, monoterpenes, sesquiterpenes, diterpenes, triterpenes, and tetraterpenes. It should also be noted that terpenes are also known by the names of the extract or essential oil which contain them, e.g. lemongrass oil contains citral.

In accordance with this aspect of the present invention, the composition may further comprise a drying agent. The drying agent may be any compound or material that, once applied to plant surfaces, desiccates spores or other materials with which it comes into contact. For example, the combination of a drying agent plus a plant treatment agent would be very damaging to soft-bodied insects such as aphids and white flies. It is expected that contact with these mixtures would cause the insects to dry up and collapse. Exemplary classes of drying agents include bicarbonates and silicates.

The composition according to this aspect of the present invention may further contain sulfur, zinc, manganese, or salts of copper. These elements have been shown to have both fungicidal and bactericidal effects.

In another embodiment, the composition contains a plurality of plant treatment agents, wherein the dextrin separates one plant treatment agent from other plant treatment agents. As described previously, certain adjuvants and chemical pesticides, for example, can be toxic to other agents present in the same composition. Not to be limited by example, surfactants can be sequestered by the dextrin resulting in safening of the formulation for microbial agents since the microbial agent does not come into contact with the surfactant until the material is diluted with water for application in the field. Similarly, microbial agents and chemical pesticides must also be separated. Accordingly, in a preferred embodiment of this aspect of the present invention, at least one plant treatment agent is a living organism.

Another aspect of the present invention relates to a method of controlling fungi, Oomycetes, bacteria, insects, nematodes, or mites that involves applying the composition described above to said fungi, Oomycetes, bacteria, insects, nematodes, or mites under conditions effective to control said fungi, Oomycetes, bacteria, insects, nematodes, or mites.

The composition can be applied to fungi, Oomycetes, bacteria, insects, nematodes, or mites in a variety of ways. In one embodiment, the composition is applied to soil, leaves, stems, flowers, fruits, seeds, roots, and/or grains.

In another embodiment, said applying comprises spraying the composition. This is particularly suitable for treating a plant disease which affects the surface of the plant. For spraying, a preparation comprising 2 g/1 of the composition in water may be used. Concentrations from 2 to 4 g/1 are particularly effective, and concentrations greater than 4 g/1 may be used as required. It is important that the concentration of the composition used is sufficient to kill or inhibit the disease causing agent, but not so high as to harm the plant being treated.

When spraying plants a rate of 100 L/Ha or greater may be suitable to cover the plants. Typically a rate of 100 to 500 L/Ha may be sufficient for crops of small plants which do not have excessive foliage; though higher rates may also be used as required. For larger plants with extensive foliage (e.g. perennial crop plants such as vines or other fruit plants) rates of 500 L/Ha or greater are generally suitable to cover the plants. Preferably a rate of 900 L/Ha or greater is used to ensure good coverage.

The composition of the present invention may also be applied by drenching soil with the composition. This is particularly suitable for treating nematodes or other soil borne pathogens or parasites.

In another embodiment, the applying step comprises mixing the composition into soil or other planting medium.

In another embodiment, the applying step comprises treating seeds with composition.

Regardless of the method of application, the plant treatment agents are released from the dextrin in a fashion whereby, upon each wetting event, a portion of the plant treatment agent is released. Wetting events may include moisture provided through irrigation, rainfall, and ingestion by insects, mites or other organisms. The remaining sequestered plant treatment agent provides residual activity after the initial spray application.

Another aspect of the present invention relates to a method that involves providing a dextrin and providing one or more plant treatment agents. The dextrin and one or more plant treatment agents are contacted under conditions effective for the dextrin and one or more plant treatment agents to interact such that some of the dextrin sequesters the one or more plant treatment agents, some of the dextrin is attached to the one or more plant treatment agents, and some of the dextrin is mixed with, but unattached to, the one or more plant treatment agents.

Dextrins and plant treatment agents are described above.

Contacting the dextrin and one or more plant treatment agents can be performed by mixing the dextrin and plant treatment agents at different ratios, with higher ratios of plant treatment agents to dextrin providing a greater percentage of free and loosely attached plant treatment agents than lower ratios.

A further aspect of the present invention relates to a composition that involves a cyclodextrin and a terpene. In this composition, the cyclodextrin and the terpene interact such that some of the cyclodextrin sequesters the terpene, some of the cyclodextrin is attached to the terpene, and some of the cyclodextrin is mixed with, but unattached to, the terpene.

Terpenes are described above.

It is important that the composition contains a range of interactions of the terpene to the cyclodextrin. Modes of interaction as well methods for controlling the range of interactions are described above. In a preferred embodiment, the cyclodextrin to terpene molar ratio is at least 1:3.

Particularly suitable terpenes for use in the present invention include those selected from the group consisting of geraniol, myrcene, lavandulol, geranial, perillene, eugenol, ionene, methone, pulegone, ascaridole, thymol, carvone, cryptone, methofuran, menthol, pinane, and pinene.

As described above, the composition may further include an adjuvant, a drying agent, sulfur, zinc, manganese, or salts of copper.

The present invention also relates to a method of controlling fungi, Oomycetes, bacteria, nematodes, or mites, that includes applying the composition described above to said fungi, Oomycetes, bacteria, insects, nematodes, or mites under conditions effective to control said fungi, Oomycetes, bacteria, insects, nematodes, or mites.

Methods of applying the composition are described previously.

A final aspect of the present invention relates to a method that involves providing a cyclodextrin and providing a terpene. The cyclodextrin and the terpene are contacted under conditions effective for the cyclodextrin and the terpene to interact such that some of the cyclodextrin sequesters the terpene, some of the cyclodextrin is attached to the terpene, and some of the cyclodextrin is mixed with, but unattached to, the terpene.

Terpenes useful in this aspect of the present invention are described above.

It is important that the composition contains a range of binding of the terpene to the cyclodextrin. Modes of binding as well methods for controlling the range of binding are described above. In a preferred embodiment, the cyclodextrin to terpene molar ratio is at least 1:3.

### EXAMPLES

The following examples are provided to illustrate embodiments of the present invention but they are by no means intended to limit its scope.

### Example 1

### Production of Useful Formulations

The nanoencapsulation or incorporation system uses cyclodextrins as the base material. Cyclodextrins are composed of a circular structure of 6-8 glucose units with a hydrophobic inner core and a hydrophilic outer layer. However, it will be appreciated that glucose units also have both hydrophobic and hydrophilic portions. Within the central cyclodextrin core, hydrophobic materials are tightly bound, but less strong binding also may occur on the outer portion. The manufacturer of cyclodextrins suggests equimolar concentrations of the added (guest) material and the cyclodextrin host material. This provides very tight binding of flavoring and other similar compounds. However, for the present applications, some free material for immediate reaction against pests or pathogens and a range of binding of the remainder that can be released upon exposure to water is desired. This is the same expectation as that with flavoring compounds, where a ‘burst’ of flavor occurs when products are moistened during chewing or similar activities. A 1:1 molar mixture of cyclodextrins and citral contains 8% citral and 92% cyclodextrin and is used for preparation of flavors. This provides very tight binding, but is not very acceptable for agricultural applications where a higher proportion of active ingredient is required and a range of binding affinities is desirable.

Preparations developed for this application combined cyclodextrins with equal quantities of eugenol and thymol (ET). Fifteen grams of cyclodextrins were added to water and, in one formulation, 7.5 g of ET was added. In another formulation, 15 g of ET was added. These were mixed for 48 hours at room temperature. At the end of this time, a milky white suspension was obtained. Under normal conditions, if this level of ET was added directly to water in the absence of cyclodextrins, an oil and water separation would occur, with the terpenoid mixture at the top of the liquid. However, in contrast, this did not occur with the cyclodextrin preparation. The milky white suspension had no phase separation and only a slight oiliness at the top of the mixture. Upon standing, the cyclodextrin solid phase settled to the bottom of the flask and was readily suspendable.

In another trial, a 5:1 molar ratio of citral was added to a similar cyclodextrin suspension in water to give a ratio of 0.4:1 citral:cyclodextrin by weight. This is 5× the rate recommended by the cyclodextrin manufacturer for flavoring uses. A similar result was obtained.

Tests were performed to determine the amounts of ET or citral that were in the aqueous and the solid phases of the cyclodextrin mixtures. In order to determine this, the materials were separated into aqueous and solid phases by centrifugation. Five mL of sample and 5 mL of water were added to a centrifuge tube, mixed thoroughly and centrifuged for 10 min at 25,000×g. The supernatant (water) was removed, and 50% ethanol was added to give the original volume of 10 mL. The tubes were spun again and the supernatant (50% ethanol) was removed. This was repeated once again. The reasoning behind this procedure was that ET or citral would be extracted from the cyclodextrins by the 50% ethanol. The supernatant mixtures were made to 50% ethanol and the optical density of all solutions was measured at 240 nm, where the materials absorb strongly. Dilutions were made as appropriate in 50% ethanol to give optical density readings between 0.1 and 0.4 units. Standard curves were then prepared of the ET or citral in 50% ethanol. The results follow in Table 1.

TABLE 1

| | Terp. in aqueous | Combined Terp. in |
|---|---|---|
| Material | suspension | cyclodextrins |
| Citral | 1.7 g/L | 9.1 g/L |
| 7.5% ET | 3.4 g/L | 60 g/L |
| 15% ET | 3.2 g/L | 90 g/L |

Thus, the guest ET or citral molecules were bound to the cyclodextrins in all cases very effectively, even though they were added very much in excess of the amount recommended for flavoring. For citral, about 85% of the total was removed into the solid phase by centrifugation and for the ET mixtures, 95 and 98% were bound. These may be low estimates since there was no attempt to prevent volatilization of the terpene mixtures during preparation. Nonetheless, the binding was highly efficient, and, in fact, for the ET mixtures, a higher percentage of free terpenes would be desirable in an agricultural product.

The 15% mixtures were added to water at the rate of 4 ml/L, which in other experiments was a useful level for a final tank for foliar application of terpenes. After a short time, a nearly crystal clear solution was obtained, as would be expected as the nanoscale cyclodextrins dissolve and disperse in water due to their hydrophobic outer layer.

It is anticipated that the formulations will be improved. Surfactants will be necessary to keep free terpenes in suspension, and gums and stickers, such as xanthan gum, will improve the suspension of the cyclodextrin-terpenoid mixtures in water suspension. Loading rates of terpenes relative to cyclodextrins may need to be greater than a 1:1 ratio by weight.

Since the terpenoid compounds evidently bind to the outer surface of cyclodextrins, it is reasonable to conclude that a less preferred embodiment of this invention will comprise an inclusion of terpenoid compounds onto the surface of noncircularized dextrins.

This multiphase system required for best efficacy in this example is in contrast with another study where the goal was to obtain maximum inclusion efficiency (Lopez et al., “Analysis of Monoterpenoids in Inclusion Complexes with B-Cyclodextrin and Study on Ratio Effect in These Microcapsules,” 10th International Working Conference on Stored Product Protection Julius-Kuhn-Archiv 425 (2010), which is hereby incorporated by reference in its entirety). This study found that the maximum sequestration required at least 3.33:1 of cyclodextrin:terpene. In contrast, in the present tests, best results were obtained with a 2:1 or a 1:1 ratio.

### Example 2

### Control of Mites in Greenhouse Trials

Two-spotted spider mites (TSSM) are frequent pests on crops of many sorts, especially in the greenhouse. A related technology (U.S. Patent Application Publication No. 2010/0136102 to Franklin et al., which is hereby incorporated by reference in its entirety) describes a related method in which the mites were controlled using a terpene formulation encapsulated in a yeast shell. In the present Example, the mites were controlled by a mixture of eugenol:thymol:citral (ETC) as described herein. The mite ratings were as follows in Table 2.

TABLE 2

| Treatment | Mite damage rating ± S.D. |
|---|---|
| Control | 5.8 ± 2.6 |
| C | 2 ± 2.4 |
| ETC | 1.8 ± 0.5 |

These data clearly demonstrate control of mites under severe conditions. The leaves on the control plants had variable numbers of mites, which is indicated by the high error bars for this treatment. This result is relatively remarkable, because (a) volatile materials were used that, in the absence of the encapsulation systems, would be expected to have a residue time on leaves in minutes or hours, and the materials were only applied at two-week intervals and (b) because encapsulated terpene formulations were chosen based on their activity against plant pathogens and simply applied the materials at a level that had been earlier used for control of powdery mildew in grapes. Thus, there was no optimization of formulations or application systems. Most importantly, these data strongly suggest that formulations and mixtures that are effective against fungal plant pathogens are also effective against mites.

These results were with non-optimized mixtures of terpenes encapsulated using a technology different from that described in this application. No doubt better and more effective mixtures can be discovered, but this provides an indication of the efficacy of the technology. However, at the end of the trial, there was one portion of the test in which a very high level of mites developed on a virus-infected plant. For commercial applications, a spreader-sticker will have to be added to the formulation. In this case, substantially improved results are likely. For example, one study (Cowles et al., ““Inert” Formulation Ingredients With Activity: Toxicity of Trisiloxane Surfactant Solutions to Twospotted Spider Mites (Acari: Tetranychidae),” J Econom. Entom. 93: 180-188 (2000), which is hereby incorporated by reference in its entirety) suggests that adjuvants that contain spreader-stickers such as trisiloxane surfactants give much higher mite control levels than that with only partially effective miticides. Materials such as Silwet L77 and Dyne-Amic contain such surfactants and gave very high levels of control in combination with other materials. These products, even though they are considered as ‘inert’ themselves have strong miticidal activity.

### Example 3

### Control of Powdery Mildew in Plants with Surfactants

It was anticipated that powdery mildews would be difficult to control with encapsulated terpenes since spores of this fungus germinate in the absence of moisture. Thus, the moisture-activated aspect of the encapsulation systems was unlikely to be effective. Therefore, the use of surfactants with and without encapsulated terpenes was investigated. Grapes were inoculated with the pathogen at the rate of 10⁴ conidia/ml with 0.01% Tween 80 to permit good spore distribution. After the pathogen spray was dry, plants were sprayed with a 16% active ingredient mixture of a 1:1:1 ETC formulation. Plants sprayed only with water served as controls, as did plants sprayed with the commercial fungicide Milstop. The results follow in Table 3. The results were taken 13 days after treatment. Incidence represents the number of lesions and severity the % leaf area affected. The values given are +/− the standard error with three replicates per treatment.

TABLE 3

| Treatment | Disease incidence | Disease severity |
|---|---|---|
| Water | 21.1 +/− 0.82 | 12.4 +/− 3.6% |
| | lesions/leaf | leaf covered |
| Milstop | 7.9 +/− 1.5 | 4.3 +/− 0.6 |
| Abound | 23.5 +/− 4.0 | 22.5 +/− 3.4 |
| Dyne-Amic | 8.8 +/− 0.8 | 4.4 +/− 0.8 |
| ETC | 14.7 +/− 4.1 | 11.6 +/− 3.4 |
| Dyne-Amic + ETC | 5 +/− 0.9 | 1.6 +/− 0.6 |

The results indicated, as expected, that ETC had significant but not very high levels of activity when used alone. Dyne-Amic, which is the same material reported in the previous example to enhance activity against mites, was effective. However, the combination of Dyne-Amic plus ETC was the most effective material, especially when disease severity is considered. The two commercial materials were moderately (Milstop) or poorly (Abound) effective against the pathogen.

The data demonstrate that it is possible to produce highly effective controls against a range of plant pathogens and pests in highly safe products (the surfactants used here can be used without restriction on any crop), but that synergistic mixtures of encapsulated terpenes frequently will have to be combined with other materials.

### Example 4

### Safening of Fungal Formulations

Formulations of Clonostachys rosea strain ACM941 were prepared with various additives, and shelf life was evaluated. One adjuvant evaluated was a sticker composed of a food grade starch material, Crystal-Tex (MSDS attached). Silwet L-77 was also tested as a surfactant. This material is silicone-based and frequently used as a pesticide formulant. Silwet L-77 has some antifungal activity, but most importantly it increases the efficacy of several different pesticides. Silwet L-77, when used as a formulant for biostimulant or biocontrol fungi, has the marked disadvantage of being toxic as an adjuvant in concentrated packaged formulations, because it will kill or damage the microbial agents. However, when diluted for spray application, this should not occur. Hence the disadvantage of this, or any other surfactant, is that it is not possible to directly use these products as a stable formulant. However, adjuvancy is essential for improved efficacy of biostimulant and biocontrol formulations. A mixture of 3 ml of Silwet sequestered in 10 g of cyclodextrin was prepared to act as a stable formulation of the surfactant that sequesters the formulant in a compound (that can be purchased as a food grade material) and that prevents contact of the surfactant with the biocontrol fungus while dry in the formulation. When the formulation is dissolved in water, the surfactant is released, thus permitting its activity.

The formulations prepared and sent were as follows:
1. C. rosea only.
2. C. rosea+0.1% sticker.
3. C. rosea+0.1% stabilized surfactant.
4. C. rosea+0.1% sticker+0.1% surfactant
Table 4 shows Clonostachys rosea, strain ACM941, in four formulations across time. Each count is the cfu (colony forming unit) value×10⁸. For example, a value of 10=1×10⁹ cfus.
CFU counts over time: Dates of testing and formulation age after storage at 5° C.

TABLE 4

| | Nov. 13, | Dec. 1, | Jan. 4, | Feb. 10, | Mar. 20, |
|---|---|---|---|---|---|
| | 2009 | 2009 | 2010 | 2010 | 2011 |
| Formulation | 0 weeks | 4 weeks | 8 weeks | 12 weeks | ~70 weeks |
| 1. C. rosea only | 36 | 33 | 25 | 26 | 4 |
| 2. C.r. + sticker | 15 | 13 | 15 | 14 | 3 |
| 3. C.r. + surfactant | 36 | 20 | 23 | 23 | 4 |
| 4. C.r. + surf. + sticker | 79 | 60 | 30 | 43 | 2 |

C.r. = C. rosea strain ACM941

These data demonstrate that neither the sticker nor the surfactant alone had much effect on the viability of the preparations for at least 12 weeks after preparation. There appeared to be more variability in the data where the C. rosea in combination with the sticker was used, but the final value at 12 weeks was still higher than the C. rosea alone at 0 weeks. Clearly, the shelf life is little affected for at least 12 weeks, which is sufficient to reach the field. At 70 weeks the viability was considerably reduced, but there was no differential effect of the formulations. It appears that the preparations have sufficient viability for commercial use. If storage was expected for extended periods of time, the preparations might need to be formulated at somewhat higher values than actually intended. In addition, for storage in the preparer's facilities, these dry formulations could be stored at −20 C, and shelf life would be excellent. This has been done with similar formulations of other fungi and is possible since the preparations are at a good storage moisture level. Thus, the nanosystem process effectively safened the mixture and provides good utility for commercial use of the formulant.

### Example 5

### Improved Efficacy of Control of Fusarium Head Blight with Nanosystem-C. rosea Formulations

Preparations prepared as described in Example 4 were tested for efficacy evaluation for the control of Fusarium head blight. Tests were conducted in the greenhouse on Quantum (cultivar wheat). Concentrations of C. rosea were 1×10⁸ cfu/m1 of C. rosea. Plants were sprayed with C. rosea using the four formulations described in the previous example at about 25 ml per spike. The plants were inoculated with the pathogen Gibberella zea (syn. Fusarium graminearum) at a concentration of 5×10⁴ conidia/ml.

Disease was evaluated as the area under the disease progress curve (AUDC), the percentage of infected spikes (% IS), yield (g/10 heads), Fusarium damaged kernels (FDK), and thousand kernel weight (TKW). The values for these parameters in the control and with each of the four formulations are provided in Table 5.

TABLE 5
Effects of different formulations of C. rosea in the control of
head blight on wheat (data is the mean of three replicates)

| | | IS | | Yield | TDW |
|---|---|---|---|---|---|
| Treatment | AUDPC | (%) | FDK | (g/10 heads) | (g) |
| Untreated | 76.1 | 62.0 | 28.3 | 2.6 | 30.5 |
| 1. C. rosea only | 26.8 | 18.7 | 9.9 | 7.4 | 37.2 |
| 2. C. r. + sticker | 22.6 | 14.1 | 13.0 | 7.4 | 37.3 |
| 3. C.r. + surfactant | 13.0 | 11.2 | 7.7 | 8.2 | 41.3 |
| 4. C.r. + surf. + sticker | 17.9 | 15.9 | 11.9 | 7.5 | 41.2 |

C.r. = C. rosea

These data clearly show that Fusarium head blight was controlled to a significant extent (P=0.05) by C. rosea. In all cases, formulation 3 (C. rosea+Silwet L-77 sequestered in cyclodextrins) gave the best results.

Disease severity (AUDPC), the % of infected spikes and Fusarium damaged kernels were all less with C.r.+surfactant than any other formulation. The yield (g/10 heads) and total test weight both increased with this treatment. These latter two values are important since G. zea damaged kernels and reduces their weight. The other formulation (4) contained sequestered Silwet and a sticker (a dextrin polymer). This formulation was somewhat less effective than 3, probably because the dextrin acted as food source for the pathogen, and thereby increased disease.

Nonetheless, the cyclodextrin sequestered Silwet-C. rosea formulation had increased efficacy over the control.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A composition comprising:
a dextrin and
one or more plant treatment agents, wherein said dextrin and said one or more plant treatment agents interact as follows: (1) some of said dextrin sequesters said one or more plant treatment agents; (2) some of said dextrin is attached to said one or more plant treatment agents; and (3) some of said dextrin is mixed with, but unattached to, said one or more plant treatment agents.

2. The composition of claim 1, wherein said dextrin to said one or more plant treatment agents molar ratio is 1:1 to 1:10.

3. The composition of claim 1, wherein said dextrin is selected from the group consisting of cyclodextrin, yellow corn dextrin, maltodextrin, and highly branched cyclic dextrin.

4. The composition of claim 3, wherein said dextrin is cyclodextrin.

5. The composition of claim 1, wherein said one or more plant treatment agents is selected from the group consisting of a microbial agent, a biostimulant, an adjuvant, a chemical pesticide, and a terpene.

6. The composition of claim 5, wherein said one or more plant treatment agents is a microbial agent.

7. The composition of claim 6, wherein said microbial agent is selected from the group consisting of Trichoderma, Clonostachys, Rhizobia, Penicillium, Piriformaspora indica, mycorrhizal fungi, foliar endophytic fungi, nonpathogenic Fusarium spp., binucleate Rhizoctonia spp., Bacillus and Pseudomonas.

8. The composition of claim 5, wherein said plant treatment agent is a biostimulant.

9. The composition of claim 8, wherein said biostimulant is selected from the group consisting of humic acid, fulvic acid, vitamins, seaweed extract, L-amino acids, and cytokinin.

10. The composition of claim 5, wherein said plant treatment agent is an adjuvant.

11. The composition of claim 10, wherein said adjuvant is a surfactant or a natural or modified vegetable oil.

12. The composition of claim 5, wherein said plant treatment agent is a chemical pesticide.

13. The composition of claim 5, wherein said plant treatment agent is a terpene.

14. The composition of claim 1 further comprising:
a drying agent.

15. The composition of claim 14, wherein the drying agent is a bicarbonate or silicate.

16. The composition of claim 1 further comprising:
sulfur, and salts of zinc, manganese, or copper.

17. The composition of claim 1 further comprising:
a plurality of plant treatment agents, wherein said dextrin separates one plant treatment agent from other plant treatment agents.

18. The composition of claim 17, wherein at least one plant treatment agent is a living organism.

19. A method of controlling fungi, Oomycetes, bacteria, insects, nematodes, or mites, said method comprising:
applying the composition of claim 1 to said fungi, Oomycetes, bacteria, insects, nematodes, or mites under conditions effective to control said fungi, Oomycetes, bacteria, insects, nematodes, or mites.

20-24. (canceled)

25. A method comprising:
providing a dextrin;
providing one or more plant treatment agents; and
contacting said dextrin with said one or more plant treatment agents under conditions effective for said dextrin and said one or more plant treatment agents to interact as follows: (1) some of said dextrin sequesters said one or more plant treatment agents; (2) some of said dextrin is attached to said one or more plant treatment agents; and (3) some of said dextrin is mixed with, but unattached to, said one or more plant treatment agents.

26-37. (canceled)

38. A composition comprising:
cyclodextrin and
a terpene, wherein said cyclodextrin and said terpene interact as follows: (1) some of said cyclodextrin sequesters said terpene; (2) some of said cyclodextrin is attached to said terpene; and (3) some of said cyclodextrin is mixed with, but unattached to, said terpene.

39. The composition of claim 38, wherein said cyclodextrin to said terpene molar ratio is at least 1:3.

40. The composition of claim 38, wherein said terpene is selected from the group consisting of geraniol, myrcene, lavandulol, geranial, perillene, eugenol, ionene, methone, pulegone, ascaridole, thymol, carvone, cryptone, methofuran, menthol, pinane, and pinene.

41. The composition of claim 38 further comprising:
an adjuvant.

42. The composition of claim 41, wherein the adjuvant is a surfactant or a natural or modified vegetable oil.

43. The composition of claim 42, wherein the adjuvant is a surfactant.

44. The composition of claim 43, wherein the surfactant is selected from the group consisting of organosilicone, polyalkylene or trioxysilane surfactants, soaps, and saponins.

45. The composition of claim 42, wherein the adjuvant is a natural or modified vegetable oil.

46. The composition of claim 38 further comprising:
a drying agent.

47. The composition of claim 46, wherein the drying agent is a bicarbonate or silicate.

48. The composition of claim 38 further comprising:
sulfur, salts of zinc, manganese, or copper.

49. A method of controlling fungi, Oomycetes, bacteria, insects, nematodes, or mites, said method comprising:
applying the composition of claim 38 to said fungi, Oomycetes, bacteria, insects, nematodes, or mites under conditions effective to control said fungi, Oomycetes, bacteria, insects, nematodes, or mites.

50-54. (canceled)

55. A method comprising:
providing a cyclodextrin;
providing a terpene; and
contacting said cyclodextrin with said terpene under conditions effective for said cyclodextrin and said terpene to interact as follows: (1) some of said cyclodextrin sequesters said terpene; (2) some of said cyclodextrin is attached to said terpene; and (3) some of said cyclodextrin is mixed with, but unattached to, said terpene.

56-57. (canceled)
